(19) United States
(12) Patent Application Publication
(10) Pub. No.: US 2026/0169290 A1
(43) Pub. Date: Jun. 18, 2026

(54) Etendue Expander for a Display

(71) Applicant: Envisics Ltd, Milton Keynes (GB)

(72) Inventor: Ruisheng Lin, Milton Keynes (GB)

(21) Appl. No.: 19/403,942

(22) Filed: Nov. 30, 2025

(30) Foreign Application Priority Data
Dec. 13, 2024 (GB) 2418307.1

(51) Int. Cl. G02B 27/01; G02B 27/00; G02B 27/09; G03H 1/04; G03H 1/16

(52) U.S. Cl. CPC G02B 27/0103; G02B 27/0018; G02B 27/0081; G02B 27/0961; G03H 1/0443; G03H 1/16; G03H 2001/045

(57) ABSTRACT

An etendue expander for a display. The etendue expander comprises a first lens arranged to form a holographic reconstruction of a hologram displayed at a first focal plane thereof. The holographic reconstruction comprises a plurality of pixels. The etendue expander comprises a plurality of microlenses. Each microlens is aligned with a respective pixel of the holographic reconstruction to form an image of the plurality of pixels. The etendue expander comprises a second lens arranged such that the image of the plurality of pixels is disposed at a first focal plane thereof and a relayed hologram is formed at a second focal plane thereof. The etendue of the relayed hologram is greater than that of the hologram.

### CROSS-REFERENCE TO RELATED APPLICATIONS

This application claims priority under 35 U.S.C. § 119 to UK Patent Application GB 2418307.1 titled “Etendue Expander for a Display,” filed on Dec. 13, 2024, and currently pending. The entire contents of GB 2418307.1 are incorporated by reference herein for all purposes.

### FIELD

The present disclosure relates to holographic image projection. More specifically, the present disclosure relates to an etendue expander and a method of expanding an etendue of a wavefront, such as a holographic wavefront. Yet more specifically, the present disclosure relates to a device and method using a plurality of microlenses within a 4f optical system in order to increase the etendue of a hologram, such as a relayed hologram or image of a hologram. Broadly, the present disclosure relates to a device and method for improving the quality of a holographic reconstruction or improving the viewing experience associated with a holographic projector, such as optimising the field of view.

### INTRODUCTION

Light scattered from an object contains both amplitude and phase information. This amplitude and phase information can be captured on, for example, a photosensitive plate by well-known interference techniques to form a holographic recording, or “hologram”, comprising interference fringes. The hologram may be reconstructed by illumination with suitable light to form a two-dimensional or three-dimensional holographic reconstruction, or replay image, representative of the original object.

Computer-generated holography may numerically simulate the interference process. A computer-generated hologram may be calculated by a technique based on a mathematical transformation such as a Fresnel or Fourier transform. These types of holograms may be referred to as Fresnel/Fourier transform holograms or simply Fresnel/Fourier holograms. A Fourier hologram may be considered a Fourier domain/plane representation of the object or a frequency domain/plane representation of the object. A computer-generated hologram may also be calculated by coherent ray tracing or a point cloud technique, for example.

A computer-generated hologram may be encoded on a spatial light modulator arranged to modulate the amplitude and/or phase of incident light. Light modulation may be achieved using electrically-addressable liquid crystals, optically-addressable liquid crystals or micro-mirrors, for example.

A spatial light modulator typically comprises a plurality of individually-addressable pixels which may also be referred to as cells or elements. The light modulation scheme may be binary, multilevel or continuous. Alternatively, the device may be continuous (i.e. is not comprised of pixels) and light modulation may therefore be continuous across the device. The spatial light modulator may be reflective meaning that modulated light is output in reflection. The spatial light modulator may equally be transmissive meaning that modulated light is output in transmission.

A holographic projector may be provided using the system described herein. Such projectors have found application in head-up displays, “HUD”.

### SUMMARY

Aspects of the present disclosure are defined in the appended independent claims.

The present disclosure relates to image projection. It relates to a method of image projection and an image projector which comprises a display device. The present disclosure also relates to a projection system comprising the image projector and a viewing system. The present disclosure is equally applicable to a monocular and binocular viewing system. The viewing system may comprise a viewer's eye or eyes. The viewing system comprises an optical element having optical power (e.g. a lens or lenses of the human eye) and a viewing plane (e.g. the retinas of the human eye or eyes). The projector may be referred to as a ‘light engine’. The display device and the image formed (or perceived) using the display device are spatially separated from one another. The image is formed, or perceived, by a viewer on a display plane. In some embodiments, the image is a virtual image and the display plane may be referred to as a virtual image plane. The image is formed by illuminating a diffractive pattern (e.g. hologram) displayed on the display device.

The display device comprises pixels. The pixels of the display device diffract light. In accordance with well-understood optics, the magnitude of the maximum diffraction angle is determined by the size of the pixels (and other factors such as the wavelength of the light).

In embodiments, the display device is a spatial light modulator such as liquid crystal on silicon (“LCOS”) spatial light modulator (SLM). Light propagates over a range of diffraction angles (for example, from zero to the maximum diffractive angle) from the LCOS, towards a viewing entity/system such as a camera or an eye. In some embodiments, magnification techniques may be used to increase the range of available diffraction angles beyond the conventional maximum diffraction angle of an LCOS. However, the principle of etendue governs any conventional magnification.

In embodiments, the image is a real image. In other embodiments, the image is a virtual image that is perceived by a human eye (or eyes). The projection system, or light engine, may thus be configured so that the viewer looks directly at the display device. In some embodiments, light encoded with the hologram is propagated directly to the eye(s) and there is no screen or other light receiving surface, between the display device and the viewer. In such embodiments, the pupil of the eye may be regarded as being the entrance aperture of the viewing system and the retina of the eye may be regarded as the viewing plane of the viewing system. It is sometimes said that, in this configuration, the lens of the eye performs a hologram-to-image conversion. In other embodiments, light encoded with an image—or simply “an image”—is propagated to the eye.

In accordance with the principles of well-understood optics, the range of angles of light propagating from a display device that can be viewed, by an eye or other viewing entity/system, varies with the distance between the display device and the viewing entity. At a 1 metre viewing distance, for example, only a small range of angles from an LCOS can propagate through an eye's pupil to form an image at the retina for a given eye position. The range of angles of light rays that are propagated from the display device, which can successfully propagate through an eye's pupil to form an image at the retina for a given eye position, determines the portion of the image that is ‘visible’ to the viewer. In other words, not all parts of the image are visible from any one point on the viewing plane (e.g. any one eye position within a viewing window such as eye-motion box.)

In some embodiments, the image perceived by a viewer is a virtual image that appears upstream of the display device—that is, the viewer perceives the image as being further away from them than the display device. Conceptually, it is possible to consider a plurality of different virtual image points of a virtual image. The distance from a virtual point to the viewer is referred to herein as a virtual image distance, for that virtual image point. Different virtual points may, of course, have different virtual image distances. Individual light rays, within ray bundles associated with each virtual point, may take different respective optical paths to the viewer, via the display device. However, only some parts of the display device, and therefore only some of the rays from one or more virtual points of a virtual image, may be within the user's field of view. In other words, only some of the light rays from some of the virtual points on the virtual image will propagate, via the display device, into the user's eye(s) and thus will be visible to the viewer. Conceptually, it may therefore be considered that the viewer is looking at a virtual image through an ‘display device-sized window’, which may be very small, for example 1 cm in diameter, at a relatively large distance, e.g. 1 metre. And the user will be viewing the display device-sized window via the pupil(s) of their eye(s), which can also be very small. Accordingly, the field of view becomes small and the specific angular range that can be seen depends heavily on the eye position, at any given time.

There has previously been disclosure (for example in UK patent GB22603517B) of how to increase the field of view—i.e., how to increase the range of angles of light rays that are propagated from the display device, and which can successfully propagate through an eye's pupil to form an image—when the display device is (in relative terms) small, and the projection distance is (in relative terms) large. In some embodiments, the projection distance is at least one—such as, at least two—orders of magnitude greater than the diameter, or width, of the aperture of the display device (i.e., size of the array of pixels). More specifically, embodiments of this prior disclosure addressed how to do this with so-called direct view holography in which a hologram of an image is propagated to the human eye rather than the image itself. In other words, the light received by the viewer is modulated according to a hologram of the image.

A waveguide is used to enable a viewer to experience the full field of view from each viewing position or, in other words, increase the maximum propagation distance over which the full diffractive angle range of the display device may be used. Use of a waveguide increases the size of the eye-box, thus enabling some movement of the user to occur, whilst still enabling the user to see the entire image. The waveguide may be referred to as a waveguide pupil expander. It was previously found, however, that for a non-infinite virtual image distance—that is, near-field virtual images—so-called ‘ghost images’ appear owing to the different possible light propagation paths through the waveguide. A ghost image is a lower intensity replica of a main image. The main, highest intensity image may be referred to as the primary image. Each ghost image may be referred to as a secondary image. The presence of ghost images can significantly reduce the quality of a perceived virtual image. The ghost images may give the appearance of blurring of the primary image.

Previous disclosures related to different approaches for addressing problems caused by the ghost images (i.e. by removing the appearance of ghost images). This included modifying/manipulating the ghost image in order to enhance or reinforce the primary/non-ghost image.

There have been disclosed different ways of increasing the field of view of the display system. GB 2308737.2 and GB 2308743.0 of 12 Jun. 2023 discloses a method comprising dividing a target picture into a plurality of portions and deflecting light by first and second deflection angles using a wavefront redirector. GB 2407680.4 of 30 May 2024 disclose an improved method of spatially interlacing a first sub-hologram and second sub-hologram using a “pixel binning” approach. GB 2407683.8 of 30 May 2024 discloses an improved wavefront redirector arranged to provide opposing diagonal turns.

There is described herein an alternative way of increasing the field of view or etendue of a display device for holograms or a holographic projection system.

The inventors have discovered another avenue for mitigating the problem of ghost images, or “ghosting”. In hologram display systems such as those described in more detail herein, light may propagate from a display device (e.g. spatial light modulator) to a so-called “4f” optical system. 4f optical systems are well known to the skilled person and typically comprise a pair of matched (i.e. having the same focal length) positive (converging) lenses which relay the light propagating from the display device to form a pupil optically downstream of the display device. In a conventional 4f optical system, the matched positive lenses may provide a 1:1 magnification of the display device, such that the field of view and the dimension of the relayed image of the display device are unchanged by the matched positive lenses. Viewed another way, the etendue of a relayed hologram (as compared to the hologram displayed on a display device) is not increased by a typical 4f system.

In accordance with the principles of well-understood optics, etendue is a property of light in an optical system that characterises how spread out the light is in terms of a product of the area of the source (i.e. either the original image of the display device or the relayed image) and the solid angle subtended by the entrance pupil as viewed from the source. It is a well understood fundamental principal arising from the laws of thermodynamics that the etendue of an optical system never decreases in any optical system where optical power is conserved. In this sense, etendue can be considered as an optical equivalent of entropy as defined in the second law of thermodynamics which states that the entropy of a closed system never decreases. Accordingly, as with an increase in entropy, an increase in etendue can be understood as an increase in the “disorder” of a bundle of light rays, and the etendue cannot then be decreased again without the use of external energy. In an idealised “perfect” version of the typical 4f system described above, the etendue remains unchanged since the matched lenses simply relay the light with a 1:1 magnification.

The inventors have discovered that that the 4f system may be modified to mitigate the effects of ghosting. Specifically, the inventors have discovered that it is desirable that the dimension of the relayed image of the display device be as large as possible in order to reduce the effects of image ghosting. This might be done by using a 4f system with a magnification factor larger than 1. However, while using a 4f system with greater magnification can enlarge the relayed image of the display device, this comes at a cost of reduced diffraction angle, and therefore reduced field of view. Another potential solution may be to increase the size of the display device in order to achieve the same field of view but with a larger pupil size. However, even a moderate increase in size of the display device would require a significant increase in the number of pixels, thus greatly increasing the cost of the display device.

Broadly, inventors have developed a 4f system that increases the etendue of the light propagating through the system by introducing a microlens array inside the 4f system. Such a modified 4f optical system is referred to generally herein as an “etendue expander”. An etendue expander as disclosed herein increases dimension of the relayed image of the display device while keeping the field of view unchanged (i.e. without a reduction in the field of view). The increased dimension of the relayed image (which can be considered as a pupil) is beneficial for reducing the effects of image ghosting. For example, the presently disclosed etendue expander is beneficial for antighosting for finite virtual image distance (for both a flat optical combiner and an optical combiner with a complex curvature).

According to a first aspect of the present disclosure, there is provided an etendue expander (in other words, an optical system that increases the etendue of light propagating through it) for a display (which, as described above, may be an “LCOS” or other spatial light modulator). The etendue expander comprises a first lens arranged to form an holographic reconstruction of a hologram displayed at a first focal plane thereof. For example, the first lens may be a positive (converging) lens with a focal length f1 and having a front (second) focal plane and a back (first) focal plane. For example, a hologram may be displayed on a display device (e.g. a spatial light modulator), such that light propagating from the display device is “encoded” with the displayed hologram. Such a display device may be placed at the front (second) focal plane of the first lens. In other words, light propagating from a display device may be focused by the first lens to form an (intermediate) image of the hologram (i.e. the hologram-encoded light) at the back (first) focal plane of the first lens. The holographic reconstruction comprises a plurality of pixels. For example, a display device (spatial light modulator) may be configured to display the hologram according to a plurality of modulation levels of respective pixels of the display device. In other words, each “pixel” of the holographic reconstruction can be considered as a “spot” of light that is imaged on the back focal plane of the first lens. The holographic reconstruction may be thought of as an intermediate image, or in other words a holographic reconstruction of the hologram displayed on the display device. The etendue expander further comprises a plurality of microlenses. The plurality of microlenses may be in the form of an array or may be in any irregular arrangement. A microlens array may be a one- or two-dimensional array of small lenses (referred to as microlenses or lenslets) which may be formed on a supporting substrate. An irregular arrangement of microlenses may have a non-repeating pattern of microlenses, for example having an amorphous structure. Each microlens (of the plurality of microlenses) is aligned with a respective pixel of the holographic reconstruction to form an image of the plurality of pixels. In other words, each microlens may be “centred” on a respective pixel, such that the optical axis of the respective microlens is (substantially) centred on the respective pixel. The plurality of microlenses may be arranged in a matching pattern to that of the pixels of the holographic reconstruction. The plurality of microlenses may comprise the same number of microlenses as the number of pixels in the holographic reconstruction. The etendue expander further comprises a second lens arranged such that the image of the plurality of pixels is disposed at a first focal plane thereof. The second lens may be a converging (positive) lens with a focal length f2 and having a front (second) focal plane and a back (first) focal plane. The optical axis of the first lens may be (substantially) aligned with the optical axis of the second lens. The focal length of the first lens f1 may be the (substantially) the same as the focal length f2 of the second lens. The etendue of the relayed hologram is greater than that of the hologram. In other words, the dimensions of the relayed hologram (in the plane perpendicular to the optical axis of the etendue expander) are larger than the dimensions of the original hologram. That is, the increased area of the relayed hologram contributes to the increase in etendue.

By providing an etendue expander according to the first aspect, the inventors have found that the microlens array positioned to align with respective pixels of the holographic reconstruction allows for an increase in the dimension of the relayed hologram while keeping the field of view unchanged. The increase in size of the relayed hologram is beneficial for mitigating image ghosting without the downsides associated with increasing the magnification factor of the 4f system or providing a display device with a higher number of pixels (higher resolution).

Furthermore, since each microlens is aligned with a respective pixel of the holographic reconstruction, the light of each pixel is acted upon by an individual microlens of the plurality. Each pixel therefore receives the same optical power and phase delay since each microlens applies the same phase delay and optical power to each pixel of the hologram image. The etendue can therefore be expanded according to the first aspect without compromising the quality of the relayed hologram, thus providing an etendue expander that is synergistic with holography.

The plurality of microlenses may be arranged in a pattern corresponding to a pattern of the plurality of pixels of the holographic reconstruction. In other words, the spatial distribution of the microlenses may match the spatial distribution of the pixels of the holographic reconstruction. Therefore, each microlens may be assigned to and aligned with a corresponding pixel of the holographic reconstruction. Each microlens therefore redirects the light associated with the corresponding pixel in order to expand the etendue of the relayed hologram. Specifically, the angle of light rays exiting each microlens may be greater than the angle of light in the absence of the microlens, thus expanding/increasing the etendue of the light as it passes through the etendue expander.

The microlens array may be positioned proximate to the (plane of) the holographic reconstruction such that light corresponding to each pixel of the holographic reconstruction falls only on the respective microlens of the plurality of microlenses. In other words, each microlens is responsible for expanding the etendue of the light of each corresponding pixel (spot) in the holographic reconstruction. By expanding the etendue on a pixel-by-pixel basis using the microlens array, the field of view of the image remains unchanged, but the size (area/dimension) of the relayed hologram is increased, thus providing an improvement in image ghosting.

The etendue of the relayed hologram may be selectable based on a distance of the plurality of microlenses from the holographic reconstruction. For example, the etendue may be increased by increasing the distance of the plurality of microlenses from the holographic reconstruction. Alternatively, the etendue may be decreased by decreasing the distance of the plurality of microlenses from the holographic reconstruction. The selection of the distance and the resultant change in etendue may be fixed during construction of the etendue expander, or may alternatively be dynamically controllable during operation (e.g. with an appropriate actuator).

The first lens and the second lens may have the same focal length. In other words, the focal length of the first lens f1 and the focal length of the second lens f2 may be equal. This means that the first and second lenses do not apply any magnification to the hologram image, thereby avoiding a reduction in field of view that would be detrimental to the quality of the holographic projection.

An angular size of a light ray bundle entering the microlenses of the plurality of microlenses from the first lens may be greater than an angular size of a light ray bundle exiting the microlenses. In this way, the etendue expander increases the angle of light incident on the second lens, resulting in an increased etendue of the relayed hologram.

The microlenses may be positive (converging/convex) lenses. In other words, the microlenses of the array may be thicker in their centres compared to their edges. In this configuration, the microlens array may be positioned between the first lens and the holographic reconstruction. In other words, the microlens array may be placed on a plane between the plane of the holographic reconstruction and a plane defined by the first lens that is perpendicular to the optical axis of the first lens. In this configuration, the angle between light rays exiting the microlenses of the array is greater than the angle between light rays entering the microlenses. In other words, the microlenses displace the position of the holographic reconstruction from its original position towards the first lens. It can therefore be understood that the microlens array forms a “new” image of the plurality of pixels of the holographic reconstruction, whereby the new image is consequently formed optically upstream of the “original” holographic reconstruction. The second lens is then arranged such that the “new” image of the plurality of pixels is disposed at a back focal plane of the second lens. In this way, the holographic reconstruction is effectively displaced towards the first lens, such that the optical length of the etendue expander may be reduced since the microlens array effectively displaces the new image upstream. Due to this axial displacement, the distance between the first and second lenses is not equal to the sum of the focal lengths of the first and second lenses (e.g. 2f when f1=f2=f).

The microlenses may alternatively be negative (diverging/concave) lenses. In other words, the microlenses of the array may be thinner in their centres compared to their edges. In this configuration, the microlens array may be positioned between the second lens and the holographic reconstruction. In other words, the microlens array may be placed on a plane between the plane of the plane of the holographic reconstruction and a plane defined by the second lens that is perpendicular to the optical axis of the second lens. In this configuration, the angle of light rays exiting the microlenses of the array is greater than the angle between light rays entering the microlenses. In other words, the microlenses displace the position of the holographic reconstruction from its original position towards the second lens such that the new image of the plurality of pixels is optically downstream of the holographic reconstruction. Because the negative microlens array is positioned between the second lens and the holographic reconstruction (i.e. the microlens array is optically downstream of the holographic reconstruction) and the new image is displaced towards the second lens, the optical length of the etendue expander may be increased since the microlens array effectively displaces the holographic reconstruction downstream. In this way, the holographic reconstruction is effectively displaced towards the second lens, such that the optical length of the etendue expander may be increased since the microlens array effectively displaces the new image upstream. Due to this axial displacement, the distance between the first and second lenses is not equal to the sum of the focal lengths of the first and second lenses (e.g. 2f when f1=f2=f).

The etendue expander may be optically connectable via the second lens to a waveguide (e.g. for pupil expansion). As discussed elsewhere herein, a pair of waveguides (for example an elongate waveguide and a flat/planar waveguide) may act to replicate the holographic wavefront along a first dimension (i.e. with the elongate waveguide) and along a second dimension (i.e. with the flat/planar waveguide), thus resulting in an expansion of the effective pupil size of the optical system in two dimensions. The relayed hologram transmitted from the second lens of the etendue expander can therefore be considered as an input to a pupil expander. Since the etendue of the relayed hologram is increased by the etendue expander disclosed herein, thus resulting in an increased size of relayed hologram, the replicated holographic wavefront transmitted by the etendue expander synergistically interacts with the waveguide pupil expander to further reduce image ghosting.

The field of view of the relayed hologram and the field of view of the (original) hologram may be the same. As explained above, the first and second lenses may apply a magnification factor of 1:1, such that the field of view of the relayed hologram is unchanged by the first and second lenses. The microlens array then acts to increase the etendue of the relayed hologram. In other words, the dimensions of the relayed hologram are increased by the introduction of the microlens array without affecting the field of view of the relayed hologram.

The etendue expander may further comprise a spatial filtering component positioned at a Fourier plane of the etendue expander. In the case of the microlenses being positive lenses, the Fourier plane of the etendue expander may be located at the plane of the holographic reconstruction. In this instance, the spatial filtering component may be located optically downstream of the microlens array. In the case of the microlenses being negative, the Fourier plane of the etendue expander may be located at the plane of the image of the plurality of pixels formed by the microlenses array. In this instance, the spatial filtering component may be located optically upstream of the microlens array. The inclusion of a spatial filtering component in a 4F system allows for the removal of undesirable portions of the transmitted holographic wavefront. For example, spatial filtering may be used to remove a zeroth-order or un-diffracted component of the holographic wavefront which may manifest as a central bright spot in the Fourier plane. A spatial filtering element may therefore be arranged to block this central zeroth-order component, thus resulting in a better viewing experience.

According to a second aspect of the present disclosure, there is provided a method of expanding an etendue of a holographic wavefront. The method comprises forming an holographic reconstruction of a hologram at a back focal plane of a first lens. The holographic reconstruction comprises a plurality of pixels. The method further comprises forming an image of the plurality of pixels with a microlens array. Each microlens is aligned with a respective pixel of the holographic reconstruction. The method further comprises forming a relayed hologram at a front focal plane of a second lens. The image of the plurality of pixels is disposed at a back focal plane of the second lens. An etendue of the relayed hologram is greater than that of the hologram.

According to a third aspect of the present disclosure, there is provided a system. The system comprises a first lens arranged to form a holographic reconstruction of a hologram displayed at a first focal plane thereof. The holographic reconstruction comprises a plurality of pixels. The system comprises a plurality of microlenses. Each microlens is aligned with a respective pixel of the holographic reconstruction to form an image of the plurality of pixels. The system comprises a second lens arranged such that the image of the plurality of pixel is disposed at a first focal plane thereof and a relayed hologram is formed at a second focal plane thereof. An etendue of the relayed hologram is greater than that of the hologram. The system comprises a first waveguide optically connected to the second lens. The first waveguide is configured to receive the relayed hologram and replicate the relayed hologram in a first dimension.

The system may further comprise a second waveguide optically connected to the first waveguide. The second waveguide may be configured to replicate the relayed hologram in a second dimension.

The term “refractive” is used herein to refer to an optical effect provided by or resulting from refraction—that is, obeying the rules of refraction or characterised by the rules of refraction. The reader will be familiar with the idea that refraction is a rotation or bending of light caused by a refractive index difference or change. The term “diffractive” is used herein to refer to an optical effect provided by or resulting from diffraction—that is, obeying the rules of diffraction or characterised by the rules of diffraction. The reader will be familiar with the idea that diffraction is caused by light spreading as it passes through an aperture or around an object.

In the present disclosure, the term “replica” is merely used to reflect that spatially modulated light is divided such that a complex light field is directed along a plurality of different optical paths. The word “replica” is used to refer to each occurrence or instance of the complex light field after a replication event—such as a partial reflection-transmission by a pupil expander. Each replica travels along a different optical path. Some embodiments of the present disclosure relate to propagation of light that is encoded with a hologram, not an image—i.e., light that is spatially modulated with a hologram of an image, not the image itself. It may therefore be said that a plurality of replicas of the hologram are formed. The person skilled in the art of holography will appreciate that the complex light field associated with propagation of light encoded with a hologram will change with propagation distance. Use herein of the term “replica” is independent of propagation distance and so the two branches or paths of light associated with a replication event are still referred to as “replicas” of each other even if the branches are a different length, such that the complex light field has evolved differently along each path. That is, two complex light fields are still considered “replicas” in accordance with this disclosure even if they are associated with different propagation distances-providing they have arisen from the same replication event or series of replication events.

A “diffracted light field” or “diffractive light field” in accordance with this disclosure is a light field formed by diffraction. A diffracted light field may be formed by illuminating a corresponding diffractive pattern. In accordance with this disclosure, an example of a diffractive pattern is a hologram and an example of a diffracted light field is a holographic light field or a light field forming a holographic reconstruction of an image. The holographic light field forms a (holographic) reconstruction of an image on a replay plane. The holographic light field that propagates from the hologram to the replay plane may be said to comprise light encoded with the hologram or light in the hologram domain. A diffracted light field is characterized by a diffraction angle determined by the smallest feature size of the diffractive structure and the wavelength of the light (of the diffracted light field). In accordance with this disclosure, it may also be said that a “diffracted light field” is a light field that forms a reconstruction on a plane spatially separated from the corresponding diffractive structure. An optical system is disclosed herein for propagating a diffracted light field from a diffractive structure to a viewer. The diffracted light field may form an image.

The term “hologram” is used to refer to the recording which contains amplitude information or phase information, or some combination thereof, regarding the object. The term “holographic reconstruction” is used to refer to the optical reconstruction of the object which is formed by illuminating the hologram. The system disclosed herein is described as a “holographic projector” because the holographic reconstruction is a real image and spatially-separated from the hologram. The term “replay field” is used to refer to the 2D area within which the holographic reconstruction is formed and fully focused. If the hologram is displayed on a spatial light modulator comprising pixels, the replay field will be repeated in the form of a plurality diffracted orders wherein each diffracted order is a replica of the zeroth-order replay field. The zeroth-order replay field generally corresponds to the preferred or primary replay field because it is the brightest replay field. Unless explicitly stated otherwise, the term “replay field” should be taken as referring to the zeroth-order replay field. The term “replay plane” is used to refer to the plane in space containing all the replay fields. The terms “image”, “replay image” and “image region” refer to areas of the replay field illuminated by light of the holographic reconstruction. In some embodiments, the “image” may comprise discrete spots which may be referred to as “image spots” or, for convenience only, “image pixels”.

The terms “encoding”, “writing” or “addressing” are used to describe the process of providing the plurality of pixels of the SLM with a respective plurality of control values which respectively determine the modulation level of each pixel. It may be said that the pixels of the SLM are configured to “display” a light modulation distribution in response to receiving the plurality of control values. Thus, the SLM may be said to “display” a hologram and the hologram may be considered an array of light modulation values or levels.

It has been found that a holographic reconstruction of acceptable quality can be formed from a “hologram” containing only phase information related to the Fourier transform of the original object. Such a holographic recording may be referred to as a phase-only hologram. Embodiments relate to a phase-only hologram but the present disclosure is equally applicable to amplitude-only holography.

The present disclosure is also equally applicable to forming a holographic reconstruction using amplitude and phase information related to the Fourier transform of the original object. In some embodiments, this is achieved by complex modulation using a so-called fully complex hologram which contains both amplitude and phase information related to the original object. Such a hologram may be referred to as a fully-complex hologram because the value (grey level) assigned to each pixel of the hologram has an amplitude and phase component. The value (grey level) assigned to each pixel may be represented as a complex number having both amplitude and phase components. In some embodiments, a fully-complex computer-generated hologram is calculated.

Reference may be made to the phase value, phase component, phase information or, simply, phase of pixels of the computer-generated hologram or the spatial light modulator as shorthand for “phase-delay”. That is, any phase value described is, in fact, a number (e.g. in the range 0 to 2π) which represents the amount of phase retardation provided by that pixel. For example, a pixel of the spatial light modulator described as having a phase value of π/2 will retard the phase of received light by π/2 radians. In some embodiments, each pixel of the spatial light modulator is operable in one of a plurality of possible modulation values (e.g. phase delay values). The term “grey level” may be used to refer to the plurality of available modulation levels. For example, the term “grey level” may be used for convenience to refer to the plurality of available phase levels in a phase-only modulator even though different phase levels do not provide different shades of grey. The term “grey level” may also be used for convenience to refer to the plurality of available complex modulation levels in a complex modulator.

The hologram therefore comprises an array of grey levels—that is, an array of light modulation values such as an array of phase-delay values or complex modulation values. The hologram is also considered a diffractive pattern because it is a pattern that causes diffraction when displayed on a spatial light modulator and illuminated with light having a wavelength comparable to, generally less than, the pixel pitch of the spatial light modulator. Reference is made herein to combining the hologram with other diffractive patterns such as diffractive patterns functioning as a lens or grating. For example, a diffractive pattern functioning as a grating may be combined with a hologram to translate the replay field on the replay plane or a diffractive pattern functioning as a lens may be combined with a hologram to focus the holographic reconstruction on a replay plane in the near field.

Although different embodiments and groups of embodiments may be disclosed separately in the detailed description which follows, any feature of any embodiment or group of embodiments may be combined with any other feature or combination of features of any embodiment or group of embodiments. That is, all possible combinations and permutations of features disclosed in the present disclosure are envisaged.

### BRIEF DESCRIPTION OF THE DRAWINGS

Specific embodiments are described by way of example only with reference to the following figures:

FIG. 1 is a schematic showing a reflective SLM producing a holographic reconstruction on a screen;

FIG. 2 shows an image for projection comprising eight image areas/components, V1 to V8, and cross-sections of the corresponding hologram channels, H1-H8;

FIG. 3 shows a hologram displayed on an LCOS that directs light into a plurality of discrete areas;

FIG. 4 shows a system, including a display device that displays a hologram that has been calculated as illustrated in FIGS. 2 and 3;

FIG. 5A shows a perspective view of a first example two-dimensional pupil expander comprising two replicators each comprising pairs of stacked surfaces;

FIG. 5B shows a perspective view of a first example two-dimensional pupil expander comprising two replicators each in the form of a solid waveguide;

FIG. 6 is a schematic view of an example display device of a holographic projection system;

FIG. 7 shows a diagram representing the maximum range of diffraction angles of a display device;

FIG. 8 is a schematic cross-sectional view of a portion of an example holographic projection system including an optical relay;

FIG. 9A is a schematic cross-sectional view of a 4f optical system arranged to relay a hologram displayed on a display device;

FIG. 9B is a schematic cross-sectional view of an etendue expander according to embodiments;

FIG. 10 shows a diagram illustrating how a microlens array forms an image of an holographic reconstruction;

FIG. 11A is a diagram showing the formation of an holographic reconstruction pixel in the absence of a microlens.

FIG. 11B is a diagram showing the formation of an image of the holographic reconstruction pixel with the use of a negative microlens.

FIG. 11C is a diagram showing the formation of an image of the holographic reconstruction pixel the use of a positive microlens.

The same reference numbers will be used throughout the drawings to refer to the same or like parts.

### DETAILED DESCRIPTION OF EMBODIMENTS

The present invention is not restricted to the embodiments described in the following but extends to the full scope of the appended claims. That is, the present invention may be embodied in different forms and should not be construed as limited to the described embodiments, which are set out for the purpose of illustration.

Terms of a singular form may include plural forms unless specified otherwise.

A structure described as being formed at an upper portion/lower portion of another structure or on/under the other structure should be construed as including a case where the structures contact each other and, moreover, a case where a third structure is disposed there between.

In describing a time relationship—for example, when the temporal order of events is described as “after”, “subsequent”, “next”, “before” or suchlike—the present disclosure should be taken to include continuous and non-continuous events unless otherwise specified. For example, the description should be taken to include a case which is not continuous unless wording such as “just”, “immediate” or “direct” is used.

Although the terms “first”, “second”, etc. may be used herein to describe various elements, these elements are not to be limited by these terms. These terms are only used to distinguish one element from another. For example, a first element could be termed a second element, and, similarly, a second element could be termed a first element, without departing from the scope of the appended claims.

Features of different embodiments may be partially or overall coupled to or combined with each other, and may be variously inter-operated with each other. Some embodiments may be carried out independently from each other, or may be carried out together in co-dependent relationship.

In the present disclosure, the term “substantially” when applied to a structural units of an apparatus may be interpreted as the technical feature of the structural units being produced within the technical tolerance of the method used to manufacture it.

### Conventional Optical Configuration for Holographic Projection

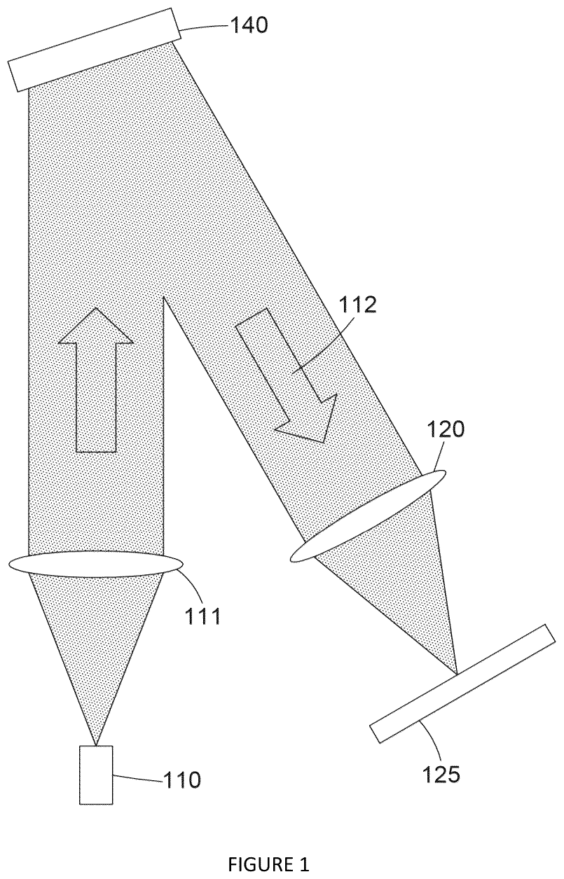

FIG. 1 shows an embodiment in which a computer-generated hologram is encoded on a single spatial light modulator. The computer-generated hologram is a Fourier transform of the object for reconstruction. It may therefore be said that the hologram is a Fourier domain or frequency domain or spectral domain representation of the object. In this embodiment, the spatial light modulator is a reflective liquid crystal on silicon, “LCOS”, device. The hologram is encoded on the spatial light modulator and a holographic reconstruction is formed at a replay field, for example, a light receiving surface such as a screen or diffuser.

A light source 110, for example a laser or laser diode, is disposed to illuminate the SLM 140 via a collimating lens 111. The collimating lens causes a generally planar wavefront of light to be incident on the SLM. In FIG. 1, the direction of the wavefront is off-normal (e.g. two or three degrees away from being truly orthogonal to the plane of the transparent layer). However, in other embodiments, the generally planar wavefront is provided at normal incidence and a beam splitter arrangement is used to separate the input and output optical paths. In the embodiment shown in FIG. 1, the arrangement is such that light from the light source is reflected off a mirrored rear surface of the SLM and interacts with a light-modulating layer to form an exit wavefront 112. The exit wavefront 112 is applied to optics including a Fourier transform lens 120, having its focus at a screen 125. More specifically, the Fourier transform lens 120 receives a beam of modulated light from the SLM 140 and performs a frequency-space transformation to produce a holographic reconstruction at the screen 125.

Notably, in this type of holography, each pixel of the hologram contributes to the whole reconstruction. There is not a one-to-one correlation between specific points (or image pixels) on the replay field and specific light-modulating elements (or hologram pixels). In other words, modulated light exiting the light-modulating layer is distributed across the replay field.

In these embodiments, the position of the holographic reconstruction in space is determined by the dioptric (focusing) power of the Fourier transform lens. In the embodiment shown in FIG. 1, the Fourier transform lens is a physical lens. That is, the Fourier transform lens is an optical Fourier transform lens and the Fourier transform is performed optically. Any lens can act as a Fourier transform lens but the performance of the lens will limit the accuracy of the Fourier transform it performs. The skilled person understands how to use a lens to perform an optical Fourier transform. In some embodiments of the present disclosure, the lens of the viewer's eye performs the hologram to image transformation.

### Hologram Calculation

In some embodiments, the computer-generated hologram is a Fourier transform hologram, or simply a Fourier hologram or Fourier-based hologram, in which an image is reconstructed in the far field by utilising the Fourier transforming properties of a positive lens. The Fourier hologram is calculated by Fourier transforming the desired light field in the replay plane back to the lens plane. Computer-generated Fourier holograms may be calculated using Fourier transforms. Embodiments relate to Fourier holography and Gerchberg-Saxton type algorithms by way of example only. The present disclosure is equally applicable to Fresnel holography and Fresnel holograms which may be calculated by a similar method. In some embodiments, the hologram is a phase or phase-only hologram. However, the present disclosure is also applicable to holograms calculated by other techniques such as those based on point cloud methods.

In some embodiments, the hologram engine is arranged to exclude from the hologram calculation the contribution of light blocked by a limiting aperture of the display system. British patent application 2101666.2, filed 5 Feb. 2021 and incorporated herein by reference, discloses a first hologram calculation method in which eye-tracking and ray tracing are used to identify a sub-area of the display device for calculation of a point cloud hologram which eliminates ghost images. The sub-area of the display device corresponds with the aperture, of the present disclosure, and is used exclude light paths from the hologram calculation. British patent application 2112213.0, filed 26 Aug. 2021 and incorporated herein by reference, discloses a second method based on a modified Gerchberg-Saxton type algorithm which includes steps of light field cropping in accordance with pupils of the optical system during hologram calculation. The cropping of the light field corresponds with the determination of a limiting aperture of the present disclosure. British patent application 2118911.3, filed 23 Dec. 2021 and also incorporated herein by reference, discloses a third method of calculating a hologram which includes a step of determining a region of a so-called extended modulator formed by a hologram replicator. The region of the extended modulator is also an aperture in accordance with this disclosure.

In some embodiments, there is provided a real-time engine arranged to receive image data and calculate holograms in real-time using the algorithm. In some embodiments, the image data is a video comprising a sequence of image frames. In other embodiments, the holograms are pre-calculated, stored in computer memory and recalled as needed for display on a SLM. That is, in some embodiments, there is provided a repository of predetermined holograms.

### Large Field of View Using Small Display Device

Broadly, the present disclosure relates to image projection. It relates to a method of image projection and an image projector which comprises a display device. The present disclosure also relates to a projection system comprising the image projector and a viewing system, in which the image projector projects or relays light from the display device to the viewing system. The present disclosure is equally applicable to a monocular and binocular viewing system. The viewing system may comprise a viewer's eye or eyes. The viewing system comprises an optical element having optical power (e.g., lens/es of the human eye) and a viewing plane (e.g., retina of the human eye/s). The projector may be referred to as a ‘light engine’. The display device and the image formed (or perceived) using the display device are spatially separated from one another. The image is formed, or perceived by a viewer, on a display plane. In some embodiments, the image is a virtual image and the display plane may be referred to as a virtual image plane. In other examples, the image is a real image formed by holographic reconstruction and the image is projected or relayed to the viewing plane. In these other examples, spatially modulated light of an intermediate holographic reconstruction formed either in free space or on a screen or other light receiving surface between the display device and the viewer, is propagated to the viewer. In both cases, an image is formed by illuminating a diffractive pattern (e.g., hologram or kinoform) displayed on the display device.

The display device comprises pixels. The pixels of the display may display a diffractive pattern or structure that diffracts light. The diffracted light may form an image at a plane spatially separated from the display device. In accordance with well-understood optics, the magnitude of the maximum diffraction angle is determined by the size of the pixels and other factors such as the wavelength of the light.

In embodiments, the display device is a spatial light modulator such as liquid crystal on silicon (“LCOS”) spatial light modulator (SLM). Light propagates over a range of diffraction angles (for example, from zero to the maximum diffractive angle) from the LCOS, towards a viewing entity/system such as a camera or an eye. In some embodiments, magnification techniques may be used to increase the range of available diffraction angles beyond the conventional maximum diffraction angle of an LCOS.

In some embodiments, the (light of a) hologram itself is propagated to the eyes. For example, spatially modulated light of the hologram (that has not yet been fully transformed to a holographic reconstruction, i.e. image)—that may be informally said to be “encoded” with/by the hologram—is propagated directly to the viewer's eyes. A real or virtual image may be perceived by the viewer. In these embodiments, there is no intermediate holographic reconstruction/image formed between the display device and the viewer. It is sometimes said that, in these embodiments, the lens of the eye performs a hologram-to-image conversion or transform. The projection system, or light engine, may be configured so that the viewer effectively looks directly at the display device.

Reference is made herein to a “light field” which is a “complex light field”. The term “light field” merely indicates a pattern of light having a finite size in at least two orthogonal spatial directions, e.g. x and y. The word “complex” is used herein merely to indicate that the light at each point in the light field may be defined by an amplitude value and a phase value, and may therefore be represented by a complex number or a pair of values. For the purpose of hologram calculation, the complex light field may be a two-dimensional array of complex numbers, wherein the complex numbers define the light intensity and phase at a plurality of discrete locations within the light field.

In accordance with the principles of well-understood optics, the range of angles of light propagating from a display device that can be viewed, by an eye or other viewing entity/system, varies with the distance between the display device and the viewing entity. At a 1 metre viewing distance, for example, only a small range of angles from an LCOS can propagate through an eye's pupil to form an image at the retina for a given eye position. The range of angles of light rays that are propagated from the display device, which can successfully propagate through an eye's pupil to form an image at the retina for a given eye position, determines the portion of the image that is ‘visible’ to the viewer. In other words, not all parts of the image are visible from any one point on the viewing plane (e.g., any one eye position within a viewing window such as eye-box.)

In some embodiments, the image perceived by a viewer is a virtual image that appears upstream of the display device—that is, the viewer perceives the image as being further away from them than the display device. Conceptually, it may therefore be considered that the viewer is looking at a virtual image through an ‘display device-sized window’, which may be very small, for example 1 cm in diameter, at a relatively large distance, e.g., 1 metre. And the user will be viewing the display device-sized window via the pupil(s) of their eye(s), which can also be very small. Accordingly, the field of view becomes small and the specific angular range that can be seen depends heavily on the eye position, at any given time.

A pupil expander addresses the problem of how to increase the range of angles of light rays that are propagated from the display device that can successfully propagate through an eye's pupil to form an image. The display device is generally (in relative terms) small and the projection distance is (in relative terms) large. In some embodiments, the projection distance is at least one—such as, at least two—orders of magnitude greater than the diameter, or width, of the entrance pupil and/or aperture of the display device (i.e., size of the array of pixels).

Use of a pupil expander increases the viewing area (i.e., user's eye-box) laterally, thus enabling some movement of the eye/s to occur, whilst still enabling the user to see the image. As the skilled person will appreciate, in an imaging system, the viewing area (user's eye box) is the area in which a viewer's eyes can perceive the image. The present disclosure encompasses non-infinite virtual image distances—that is, near-field virtual images.

Conventionally, a two-dimensional pupil expander comprises one or more one-dimensional optical waveguides each formed using a pair of opposing reflective surfaces, in which the output light from a surface forms a viewing window or eye-box. Light received from the display device (e.g., spatially modulated light from a LCOS) is replicated by the or each waveguide so as to increase the field of view (or viewing area) in at least one dimension. In particular, the waveguide enlarges the viewing window due to the generation of extra rays or “replicas” by division of amplitude of the incident wavefront.

The display device may have an active or display area having a first dimension that may be less than 10 cms such as less than 5 cms or less than 2 cms. The propagation distance between the display device and viewing system may be greater than 1 m such as greater than 1.5 m or greater than 2 m. The optical propagation distance within the waveguide may be up to 2 m such as up to 1.5 m or up to 1 m. The method may be capable of receiving an image and determining a corresponding hologram of sufficient quality in less than 20 ms such as less than 15 ms or less than 10 ms.

In some embodiments-described only by way of example of a diffracted or holographic light field in accordance with this disclosure—a hologram is configured to route light into a plurality of channels, each channel corresponding to a different part (i.e. sub-area) of an image. The channels formed by the diffractive structure are referred to herein as “hologram channels” merely to reflect that they are channels of light encoded by the hologram with image information. It may be said that the light of each channel is in the hologram domain rather than the image or spatial domain. In some embodiments, the hologram is a Fourier or Fourier transform hologram and the hologram domain is therefore the Fourier or frequency domain. The hologram may equally be a Fresnel or Fresnel transform hologram. The hologram may also be a point cloud hologram. The hologram is described herein as routing light into a plurality of hologram channels to reflect that the image that can be reconstructed from the hologram has a finite size and can be arbitrarily divided into a plurality of image sub-areas, wherein each hologram channel would correspond to each image sub-area. Importantly, the hologram of this example is characterised by how it distributes the image content when illuminated. Specifically and uniquely, the hologram divides the image content by angle. That is, each point on the image is associated with a unique light ray angle in the spatially modulated light formed by the hologram when illuminated—at least, a unique pair of angles because the hologram is two-dimensional. For the avoidance of doubt, this hologram behaviour is not conventional. The spatially modulated light formed by this special type of hologram, when illuminated, may be divided into a plurality of hologram channels, wherein each hologram channel is defined by a range of light ray angles (in two-dimensions). It will be understood from the foregoing that any hologram channel (i.e. sub-range of light ray angles) that may be considered in the spatially modulated light will be associated with a respective part or sub-area of the image. That is, all the information needed to reconstruct that part or sub-area of the image is contained within a sub-range of angles of the spatially modulated light formed from the hologram of the image. When the spatially modulated light is observed as a whole, there is not necessarily any evidence of a plurality of discrete light channels.

Nevertheless, the hologram may still be identified. For example, if only a continuous part or sub-area of the spatially modulated light formed by the hologram is reconstructed, only a sub-area of the image should be visible. If a different, continuous part or sub-area of the spatially modulated light is reconstructed, a different sub-area of the image should be visible. A further identifying feature of this type of hologram is that the shape of the cross-sectional area of any hologram channel substantially corresponds to (i.e. is substantially the same as) the shape of the entrance pupil although the size may be different—at least, at the correct plane for which the hologram was calculated. Each light/hologram channel propagates from the hologram at a different angle or range of angles. Whilst these are example ways of characterising or identifying this type of hologram, other ways may be used. In summary, the hologram disclosed herein is characterised and identifiable by how the image content is distributed within light encoded by the hologram. Again, for the avoidance of any doubt, reference herein to a hologram configured to direct light or angularly-divide an image into a plurality of hologram channels is made by way of example only and the present disclosure is equally applicable to pupil expansion of any type of holographic light field or even any type of diffractive or diffracted light field.

The system can be provided in a compact and streamlined physical form. This enables the system to be suitable for a broad range of real-world applications, including those for which space is limited and real-estate value is high. For example, it may be implemented in a head-up display (HUD) such as a vehicle or automotive HUD.

In accordance with the present disclosure, pupil expansion is provided for diffracted or diffractive light, which may comprise diverging ray bundles. The diffracted light field may be defined by a “light cone”. Thus, the size of the diffracted light field (as defined on a two-dimensional plane) increases with propagation distance from the corresponding diffractive structure (i.e. display device). It can be said that the pupil expander/s replicate the hologram or form at least one replica of the hologram, to convey that the light delivered to the viewer is spatially modulated in accordance with a hologram.

In some embodiments, two one-dimensional waveguide pupil expanders are provided, each one-dimensional waveguide pupil expander being arranged to effectively increase the size of the exit pupil of the system by forming a plurality of replicas or copies of the exit pupil (or light of the exit pupil) of the spatial light modulator. The exit pupil may be understood to be the physical area from which light is output by the system. It may also be said that each waveguide pupil expander is arranged to expand the size of the exit pupil of the system. It may also be said that each waveguide pupil expander is arranged to expand/increase the size of the eye box within which a viewer's eye can be located, in order to see/receive light that is output by the system.

### Light Channeling

The hologram formed in accordance with some embodiments, angularly-divides the image content to provide a plurality of hologram channels which may have a cross-sectional shape defined by an aperture of the optical system. The hologram is calculated to provide this channeling of the diffracted light field. In some embodiments, this is achieved during hologram calculation by considering an aperture (virtual or real) of the optical system, as described above.

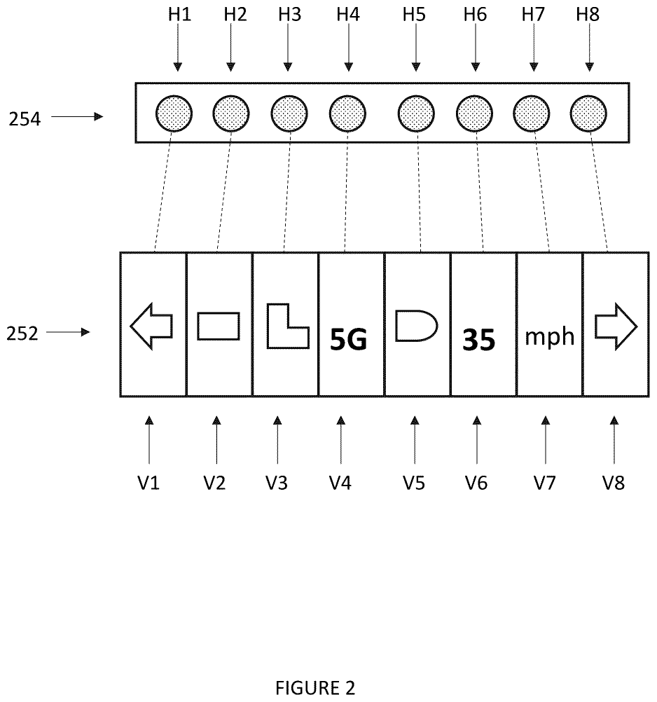

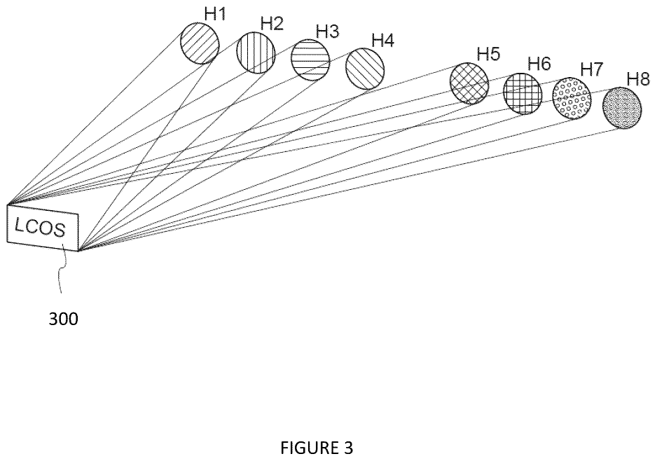

FIGS. 2 and 3 show an example of this type of hologram that may be used in conjunction with a pupil expander as disclosed herein. However, this example should not be regarded as limiting with respect to the present disclosure.

FIG. 2 shows an image 252 for projection comprising eight image areas/components, V1 to V8. FIG. 2 shows eight image components by way of example only and the image 252 may be divided into any number of components. FIG. 2 also shows an encoded light pattern 254 (i.e., hologram) that can reconstruct the image 252—e.g., when transformed by the lens of a suitable viewing system. The encoded light pattern 254 comprises first to eighth sub-holograms or components, H1 to H8, corresponding to the first to eighth image components/areas, V1 to V8. FIG. 2 further shows how a hologram may decompose the image content by angle. The hologram may therefore be characterised by the channelling of light that it performs. This is illustrated in FIG. 3. Specifically, the hologram in this example directs light into a plurality of discrete areas. The discrete areas are discs in the example shown but other shapes are envisaged. The size and shape of the optimum disc may, after propagation through the waveguide, be related to the size and shape of an aperture of the optical system such as the entrance pupil of the viewing system.

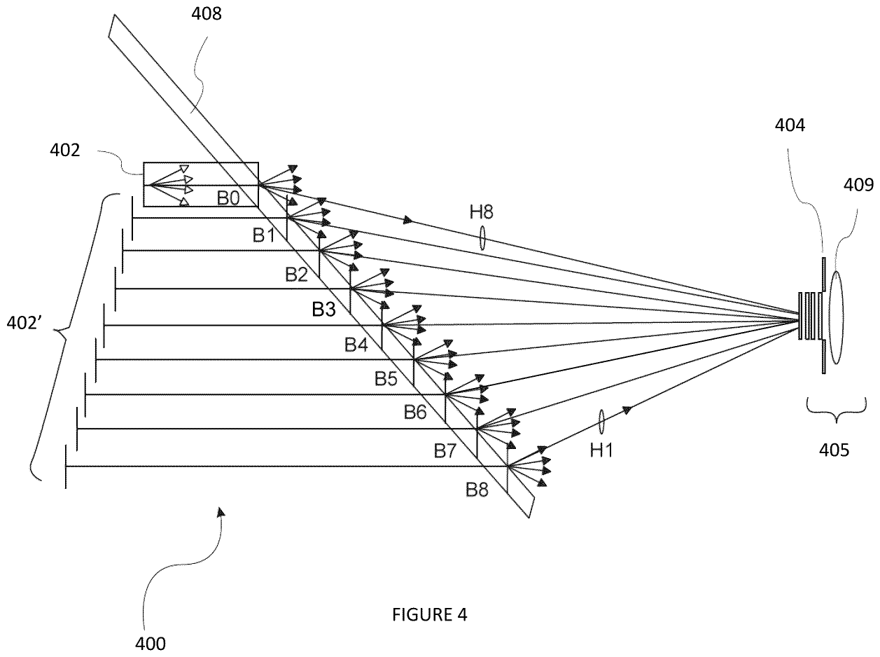

FIG. 4 shows a system 400, including a display device that displays a hologram that has been calculated as illustrated in FIGS. 2 and 3.

The system 400 comprises a display device, which in this arrangement comprises an LCOS 402. The LCOS 402 is arranged to display a modulation pattern (or ‘diffractive pattern’) comprising the hologram and to project light that has been holographically encoded towards an eye 405 that comprises a pupil that acts as an aperture 404, a lens 409, and a retina (not shown) that acts as a viewing plane. There is a light source (not shown) arranged to illuminate the LCOS 402. The lens 409 of the eye 405 performs a hologram-to-image transformation. The light source may be of any suitable type. For example, it may comprise a laser light source.

The viewing system 400 further comprises a waveguide 408 positioned between the LCOS 402 and the eye 405. The presence of the waveguide 408 enables all angular content from the LCOS 402 to be received by the eye, even at the relatively large projection distance shown. This is because the waveguide 508 acts as a pupil expander, in a manner that is well known and so is described only briefly herein.

In brief, the waveguide 408 shown in FIG. 4 comprises a substantially elongate formation. In this example, the waveguide 408 comprises an optical slab of refractive material, but other types of waveguide are also well known and may be used. The waveguide 408 is located so as to intersect the light cone (i.e., the diffracted light field) that is projected from the LCOS 402, for example at an oblique angle. In this example, the size, location, and position of the waveguide 408 are configured to ensure that light from each of the eight ray bundles, within the light cone, enters the waveguide 408. Light from the light cone enters the waveguide 408 via its first planar surface (located nearest the LCOS 402) and is guided at least partially along the length of the waveguide 408, before being emitted via its second planar surface, substantially opposite the first surface (located nearest the eye). As will be well understood, the second planar surface is partially reflective, partially transmissive. In other words, when each ray of light travels within the waveguide 408 from the first planar surface and hits the second planar surface, some of the light will be transmitted out of the waveguide 408 and some will be reflected by the second planar surface, back towards the first planar surface. The first planar surface is reflective, such that all light that hits it, from within the waveguide 408, will be reflected back towards the second planar surface. Therefore, some of the light may simply be refracted between the two planar surfaces of the waveguide 408 before being transmitted, whilst other light may be reflected, and thus may undergo one or more reflections, (or ‘bounces’) between the planar surfaces of the waveguide 408, before being transmitted.

FIG. 4 shows a total of nine “bounce” points, B0 to B8, along the length of the waveguide 408. Although light relating to all points of the image (V1-V8) as shown in FIG. 2 is transmitted out of the waveguide at each “bounce” from the second planar surface of the waveguide 408, only the light from one angular part of the image (e.g. light of one of V1 to V8) has a trajectory that enables it to reach the eye 405, from each respective “bounce” point, B0 to B8. Moreover, light from a different angular part of the image, V1 to V8, reaches the eye 405 from each respective “bounce” point. Therefore, each angular channel of encoded light reaches the eye only once, from the waveguide 408, in the example of FIG. 4.

The waveguide 408 forms a plurality of replicas of the hologram, at the respective “bounce” points B1 to B8 along its length, corresponding to the direction of pupil expansion. As shown in FIG. 4, the plurality of replicas may be extrapolated back, in a straight line, to a corresponding plurality of replica or virtual display devices 402′. This process corresponds to the step of “unfolding” an optical path within the waveguide, so that a light ray of a replica is extrapolated back to a “virtual surface” without internal reflection within the waveguide. Thus, the light of the expanded exit pupil may be considered to originate from a virtual surface (also called an “extended modulator” herein) comprising the display device 402 and the replica display devices 402′.

Although virtual images, which require the eye to transform received modulated light in order to form a perceived image, have generally been discussed herein, the methods and arrangements described herein can be applied to real images.

### Two-Dimensional Pupil Expansion

Whilst the arrangement shown in FIG. 4 includes a single waveguide that provides pupil expansion in one dimension, pupil expansion can be provided in more than one dimension, for example in two dimensions. Moreover, whilst the example in FIG. 4 uses a hologram that has been calculated to create channels of light, each corresponding to a different portion of an image, the present disclosure and the systems that are described herebelow are not limited to such a hologram type.

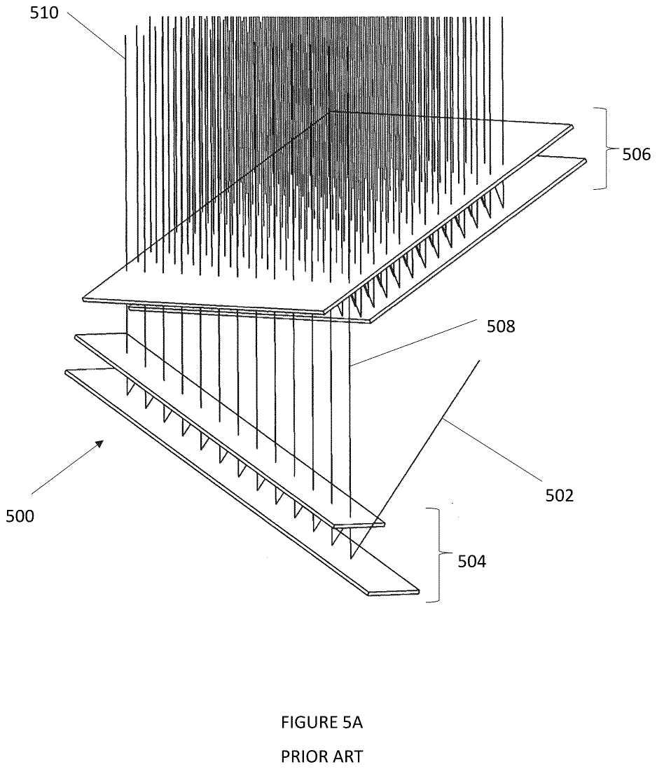

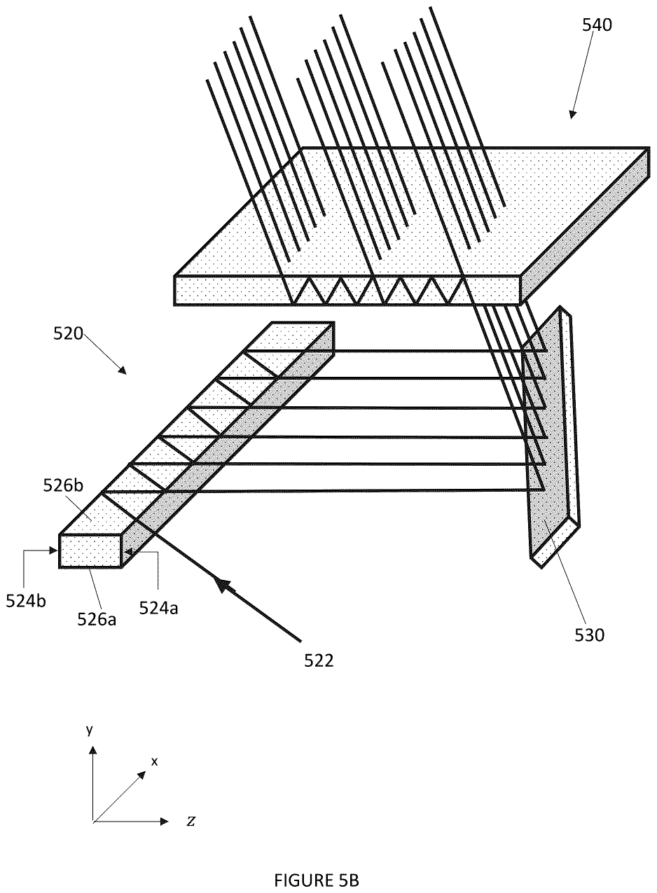

FIG. 5A shows a perspective view of a system 500 comprising two replicators, 504, 506 arranged for expanding a light beam 502 in two dimensions.

In the system 500 of FIG. 5A, the first replicator 504 comprises a first pair of surfaces, stacked parallel to one another, and arranged to provide replication—or, pupil expansion—in a similar manner to the waveguide 408 of FIG. 4. The first pair of surfaces are similarly (in some cases, identically) sized and shaped to one another and are substantially elongate in one direction. The collimated light beam 502 is directed towards an input on the first replicator 504. Due to a process of internal reflection between the two surfaces, and partial transmission of light from each of a plurality of output points on one of the surfaces (the upper surface, as shown in FIG. 5A), which will be familiar to the skilled reader, light of the light beam 502 is replicated in a first direction, along the length of the first replicator 504. Thus, a first plurality of replica light beams 508 is emitted from the first replicator 504, towards the second replicator 506.

The second replicator 506 comprises a second pair of surfaces stacked parallel to one another, arranged to receive each of the collimated light beams of the first plurality of light beams 508 and further arranged to provide replication—or, pupil expansion—by expanding each of those light beams in a second direction, substantially orthogonal to the first direction. The first pair of surfaces are similarly (in some cases, identically) sized and shaped to one another and are substantially rectangular. The rectangular shape is implemented for the second replicator in order for it to have length along the first direction, in order to receive the first plurality of light beams 508, and to have length along the second, orthogonal direction, in order to provide replication in that second direction. Due to a process of internal reflection between the two surfaces, and partial transmission of light from each of a plurality of output points on one of the surfaces (the upper surface, as shown in FIG. 5A), light of each light beam within the first plurality of light beams 508 is replicated in the second direction. Thus, a second plurality of light beams 510 is emitted from the second replicator 506, wherein the second plurality of light beams 510 comprises replicas of the input light beam 502 along each of the first direction and the second direction. Thus, the second plurality of light beams 510 may be regarded as comprising a two-dimensional grid, or array, of replica light beams.

Thus, it can be said that the first and second replicators 504, 505 of FIG. 5A combine to provide a two-dimensional replicator (or, “two-dimensional pupil expander”). Thus, the replica light beams 510 may be emitted along an optical path to an expanded eye-box of a display system, such as a head-up display.

In the system of FIG. 5A, the first replicator 504 is a waveguide comprising a pair of elongate rectilinear reflective surfaces, stacked parallel to one another, and, similarly, the second replicator 504 is a waveguide comprising a pair of rectangular reflective surfaces, stacked parallel to one another. In other systems, the first replicator may be a solid elongate rectilinear waveguide and the second replicator may be a solid planar rectangular shaped waveguide, wherein each waveguide comprises an optically transparent solid material such as glass. In this case, the pair of parallel reflective surfaces are formed by a pair of opposed major sidewalls optionally comprising respective reflective and reflective-transmissive surface coatings, familiar to the skilled reader.

FIG. 5B shows a perspective view of a system 500 comprising two replicators, 520, 540 arranged for replicating a light beam 522 in two dimensions, in which the first replicator is a solid elongated waveguide 520 and the second replicator is a solid planar waveguide 540.

In the system of FIG. 5B, the first replicator/waveguide 520 is arranged so that its pair of elongate parallel reflective surfaces 524a, 524b are perpendicular to the plane of the second replicator/waveguide 540. Accordingly, the system comprises an optical coupler arranged to couple light from an output port of first replicator 520 into an input port of the second replicator 540. In the illustrated arrangement, the optical coupler is a planar/fold mirror 530 arranged to fold or turn the optical path of light to achieve the required optical coupling from the first replicator to the second replicator. As shown in FIG. 5B, the mirror 530 is arranged to receive light-comprising a one-dimensional array of replicas extending in the first dimension—from the output port/reflective-transmissive surface 524a of the first replicator/waveguide 520. The mirror 530 is tilted so as to redirect the received light onto an optical path to an input port in the (fully) reflective surface of second replicator 540 at an angle to provide waveguiding and replica formation, along its length in the second dimension. It will be appreciated that the mirror 530 is one example of an optical element that can redirect the light in the manner shown, and that one or more other elements may be used instead, to perform this task.

In the illustrated arrangement, the (partially) reflective-transmissive surface 524a of the first replicator 520 is adjacent the input port of the first replicator/waveguide 520 that receives input beam 522 at an angle to provide waveguiding and replica formation, along its length in the first dimension. Thus, the input port of first replicator/waveguide 520 is positioned at an input end thereof at the same surface as the reflective-transmissive surface 524a. The skilled reader will understand that the input port of the first replicator/waveguide 520 may be at any other suitable position.

Accordingly, the arrangement of FIG. 5B enables the first replicator 520 and the mirror 530 to be provided as part of a first relatively thin layer in a plane in the first and third dimensions (illustrated as an x-z plane). In particular, the size or “height” of a first planar layer—in which the first replicator 520 is located—in the second dimension (illustrated as the y dimension) is reduced. The mirror 530 is configured to direct the light away from a first layer/plane, in which the first replicator 520 is located (i.e. the “first planar layer”), and direct it towards a second layer/plane, located above and substantially parallel to the first layer/plane, in which the second replicator 540 is located (i.e. a “second planar layer”). Thus, the overall size or “height” of the system-comprising the first and second replicators 520, 540 and the mirror 530 located in the stacked first and second planar layers in the first and third dimensions (illustrated as an x-z plane)—in the second dimension (illustrated as the y dimension) is compact. The skilled reader will understand that many variations of the arrangement of FIG. 5B for implementing the present disclosure are possible and contemplated.

The image projector may be arranged to project a diverging or diffracted light field. In some embodiments, the light field is encoded with a hologram. In some embodiments, the diffracted light field comprises diverging ray bundles. In some embodiments, the image formed by the diffracted light field is a virtual image.

In some embodiments, the first pair of parallel/complementary surfaces are elongate or elongated surfaces, being relatively long along a first dimension and relatively short along a second dimension, for example being relatively short along each of two other dimensions, with each dimension being substantially orthogonal to each of the respective others. The process of reflection/transmission of the light between/from the first pair of parallel surfaces is arranged to cause the light to propagate within the first waveguide pupil expander, with the general direction of light propagation being in the direction along which the first waveguide pupil expander is relatively long (i.e., in its “elongate” direction).

There is disclosed herein a system that forms an image using diffracted light and provides an eye-box size and field of view suitable for real-world application—e.g. in the automotive industry by way of a head-up display. The diffracted light is light forming a holographic reconstruction of the image from a diffractive structure—e.g. hologram such as a Fourier or Fresnel hologram. The use diffraction and a diffractive structure necessitates a display device with a high density of very small pixels (e.g. 1 micrometer)—which, in practice, means a small display device (e.g. 1 cm).

In some embodiments, the display system comprises a display device—such as a pixelated display device, for example a spatial light modulator (SLM) or Liquid Crystal on Silicon (LCoS) SLM—which is arranged to provide or form the diffracted or diverging light. In such aspects, the aperture of the spatial light modulator (SLM) is a limiting aperture of the system. That is, the aperture of the spatial light modulator-more specifically, the size of the area delimiting the array of light modulating pixels comprised within the SLM-determines the size (e.g. spatial extent) of the light ray bundle that can exit the system. In accordance with this disclosure, it is stated that the exit pupil of the system is expanded to reflect that the exit pupil of the system (that is limited by the small display device having a pixel size for light diffraction) is made larger or bigger or greater in spatial extend by the use of at least one pupil expander.

The diffracted or diverging light field may be said to have “a light field size”, defined in a direction substantially orthogonal to a propagation direction of the light field. Because the light is diffracted/diverging, the light field size increases with propagation distance.

In some embodiments, the diffracted light field is spatially-modulated in accordance with a hologram. In other words, in such aspects, the diffractive light field comprises a “holographic light field”. The hologram may be displayed on a pixelated display device. The hologram may be a computer-generated hologram (CGH). It may be a Fourier hologram or a Fresnel hologram or a point-cloud hologram or any other suitable type of hologram. The hologram may, optionally, be calculated so as to form channels of hologram light, with each channel corresponding to a different respective portion of an image that is intended to be viewed (or perceived, if it is a virtual image) by the viewer. The pixelated display device may be configured to display a plurality of different holograms, in succession or in sequence. Each of the aspects and embodiments disclosed herein may be applied to the display of multiple holograms.

The output port of the first waveguide pupil expander may be coupled to an input port of a second waveguide pupil expander. The second waveguide pupil expander may be arranged to guide the diffracted light field—including some of, preferably most of, preferably all of, the replicas of the light field that are output by the first waveguide pupil expander—from its input port to a respective output port by internal reflection between a third pair of parallel surfaces of the second waveguide pupil expander.

The first waveguide pupil expander may be arranged to provide pupil expansion, or replication, in a first direction and the second waveguide pupil expander may be arranged to provide pupil expansion, or replication, in a second, different direction. The second direction may be substantially orthogonal to the first direction. The second waveguide pupil expander may be arranged to preserve the pupil expansion that the first waveguide pupil expander has provided in the first direction and to expand (or, replicate) some of, preferably most of, preferably all of, the replicas that it receives from the first waveguide pupil expander in the second, different direction. The second waveguide pupil expander may be arranged to receive the light field directly or indirectly from the first waveguide pupil expander. One or more other elements may be provided along the propagation path of the light field between the first and second waveguide pupil expanders.

The first waveguide pupil expander may be substantially elongated and the second waveguide pupil expander may be substantially planar. The elongated shape of the first waveguide pupil expander may be defined by a length along a first dimension. The planar, or rectangular, shape of the second waveguide pupil expander may be defined by a length along a first dimension and a width, or breadth, along a second dimension substantially orthogonal to the first dimension. A size, or length, of the first waveguide pupil expander along its first dimension make correspond to the length or width of the second waveguide pupil expander along its first or second dimension, respectively. A first surface of the pair of parallel surfaces of the second waveguide pupil expander, which comprises its input port, may be shaped, sized, and/or located so as to correspond to an area defined by the output port on the first surface of the pair of parallel surfaces on the first waveguide pupil expander, such that the second waveguide pupil expander is arranged to receive each of the replicas output by the first waveguide pupil expander.

The first and second waveguide pupil expander may collectively provide pupil expansion in a first direction and in a second direction perpendicular to the first direction, optionally, wherein a plane containing the first and second directions is substantially parallel to a plane of the second waveguide pupil expander. In other words, the first and second dimensions that respectively define the length and breadth of the second waveguide pupil expander may be parallel to the first and second directions, respectively, (or to the second and first directions, respectively) in which the waveguide pupil expanders provide pupil expansion. The combination of the first waveguide pupil expander and the second waveguide pupil expander may be generally referred to as being a “pupil expander”.

It may be said that the expansion/replication provided by the first and second waveguide expanders has the effect of expanding an exit pupil of the display system in each of two directions. An area defined by the expanded exit pupil may, in turn define an expanded eye-box area, from which the viewer can receive light of the input diffracted or diverging light field. The eye-box area may be said to be located on, or to define, a viewing plane.

The two directions in which the exit pupil is expanded may be coplanar with, or parallel to, the first and second directions in which the first and second waveguide pupil expanders provide replication/expansion. Alternatively, in arrangements that comprise other elements such as an optical combiner, for example the windscreen (or, windshield) of a vehicle, the exit pupil may be regarded as being an exit pupil from that other element, such as from the windscreen. In such arrangements, the exit pupil may be non-coplanar and non-parallel with the first and second directions in which the first and second waveguide pupil expanders provide replication/expansion. For example, the exit pupil may be substantially perpendicular to the first and second directions in which the first and second waveguide pupil expanders provide replication/expansion.

The viewing plane, and/or the eye-box area, may be non-coplanar or non-parallel to the first and second directions in which the first and second waveguide pupil expanders provide replication/expansion. For example, a viewing plane may be substantially perpendicular to the first and second directions in which the first and second waveguide pupil expanders provide replication/expansion.

In order to provide suitable launch conditions to achieve internal reflection within the first and second waveguide pupil expanders, an elongate dimension of the first waveguide pupil expander may be tilted relative to the first and second dimensions of the second waveguide pupil expander.

### Combiner Shape Compensation

An advantage of projecting a hologram to the eye-box is that optical compensation can be encoded in the hologram (see, for example, European patent 2936252 incorporated herein by reference). The present disclosure is compatible with holograms that compensate for the complex curvature of an optical combiner used as part of the projection system. In some embodiments, the optical combiner is the windscreen of a vehicle. Full details of this approach are provided in European patent 2936252 and are not repeated here because the detailed features of those systems and methods are not essential to the new teaching of this disclosure herein and are merely exemplary of configurations that benefit from the teachings of the present disclosure.

### Light Shuttering Device

The present disclosure is also compatible with optical configurations that include a light shuttering device to control the delivery of light from a light channeling hologram to the viewer. The holographic projector may further comprise a control device arranged to control the delivery of angular channels to the eye-box position. British patent application 2108456.1, filed 14 Jun. 2021 and incorporated herein by reference, discloses the at least one waveguide pupil expander and control device. The reader will understand from at least this prior disclosure that the optical configuration of the control device is fundamentally based upon the eye-box position of the user and is compatible with any hologram calculation method that achieves the light channeling described herein. It may be said that the control device is a light shuttering or aperturing device. The light shuttering device may comprise a 1D array of apertures or windows, wherein each aperture or window independently switchable between a light transmissive and a light non-transmissive state in order to control the delivery of hologram light channels, and their replicas, to the eye-box. Each aperture or window may comprise a plurality of liquid crystal cells or pixels.

### Field of View

As described herein, a holographic projector comprises display device (e.g., spatial light modulator) and, optionally, a pupil replicator or expander. The display device is encoded with a hologram of a target picture and is illuminated with light in order to output light that is spatially modulated according to the hologram. The output light comprises a wavefront for forming a holographic reconstruction of the target picture. The pupil replicator relays the wavefront to an eye-box. In some embodiments, the pupil replicator comprises first and second pupil replicators, which replicate the wavefront in two dimensions as described above. In some arrangements, the (replicated) wavefront is relayed to an optical combiner, which reflects at least a portion of the wavefront to the eye-box to form a virtual image. A viewing system (e.g., the pupil of a user) is positioned at the eye-box to receive light of the wavefront. A holographic reconstruction is viewable from the eye-box.

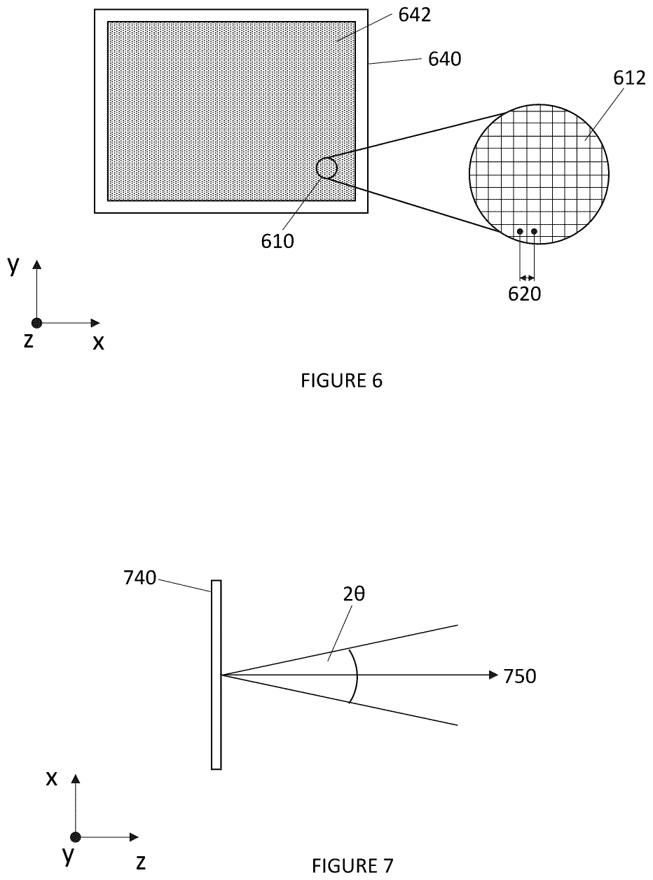

FIG. 6 shows a schematic view of an example display device 640 of a holographic projection system. In this example, the display device 640 is a pixelated liquid crystal on silicon (LCoS) spatial light modulator. The display device 640 comprises a display area 642 containing the pixels of the display device in periodic array of rows and columns. A portion 610 of the display device 640 is magnified to more clearly show how individual pixels 612 of the display device 640 are arranged in an array. In this example, each pixel 612 is square. A pixel pitch 620 of the display device 640 is defined as the distance between the respective centres of adjacent pixels 612 in the array. In this example, since the pixels 612 are square, the pixel pitch 620 is equal in a first (x) direction and second (y) direction that is perpendicular to the first (x) direction.

The (maximum) diffraction angle of the display device 640 is dependent on this pixel pitch, according to the following equation:

$$θ = \pm {sin}^{- 1} ( \frac{λ}{2 x} )$$

where θ is the diffraction angle, λ is the wavelength of incident light and x is the pixel pitch 620.

FIG. 7 represents the maximum range of diffraction angles of the display device 740. The central arrow 750 represents a projection axis of the holographic projection system. In all examples, the size of the field of view, and this the size of the holographic reconstruction or replay field, of a holographic projection system is dependent on the maximum diffraction angle. For example, the field of view of a holographic projection system may be substantially equal to 2θ.

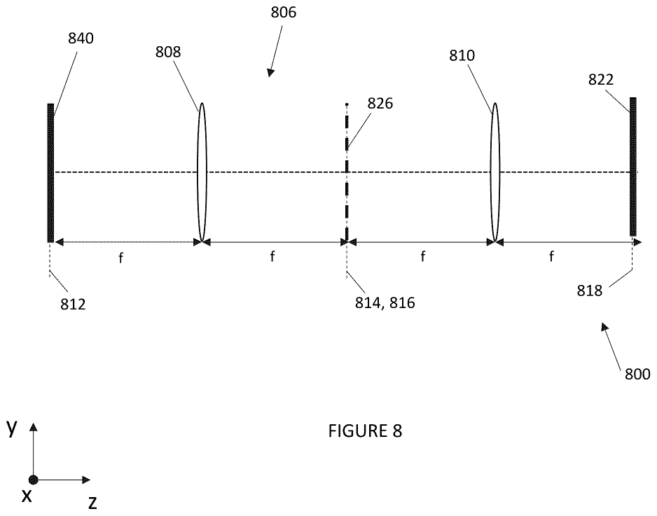

FIG. 8 shows a schematic cross-sectional view of portion of an example holographic projection system 800. The holographic projection system 800 comprises a display device 840 and an optical relay 806 downstream of the display device 840. The optical relay 806 comprises a first lens 808 and a second lens 810 downstream of the first lens 808. In this example, the optical power of the first lens 808 is equal to the optical power of the second lens 810. Furthermore, the focal length of the first and second lenses 808, 810 are the same (and are equal to f, as represented by the arrows in FIG. 8). The first lens 808 comprises a front focal plane 812 and a back focal plane 814. The second lens 810 comprises a front focal plane 816 and a back focal plane 818. The back focal plane 814 of the first lens 808 and the front focal plane 816 of the second lens 810 are co-planar. Thus, the optical relay 806 may be referred to as a “4f” system because the distance between the front focal plane 812 of the first lens 808 and the back focal plane 818 of the second lens 810 is equal to four times the focal length, f, of the first and second lens 808, 810. The display device 840 is substantially coplanar with the front focal plane 812 of the first lens 808.

The display device 840 in this example is an LCOS spatial light modulator. The display device 840 is arranged to display a sequence of holograms of a respective sequence of target pictures. The display device 840 is arranged to be illuminated by coherent light from a light source (such as laser light of a laser). The display device 840 is arranged to spatially modulate the light incident thereon in accordance with a respective hologram of a respective target picture. This forms a holographic wavefront. The holographic projection system 800 is arranged such that the holographic wavefront is relayed/propagated to the optical relay 806 to be received by the first lens 808 and the second lens 810 in turn. The first lens 908 of the optical relay is arranged to form a holographic reconstruction 826. This holographic reconstruction 826 may be formed substantially at the back focal plane 812 of the first lens 808. The second lens 810 is arranged to form a relayed hologram 822 at the back focal plane 818. The relayed hologram 822 corresponds to the display device (comprising the displayed hologram of the target picture).

The holographic projection system 800 may further comprise first and second waveguides (not shown) downstream of the optical relay 806. It should be understood that the processed holographic wavefront is relayed from the optical relay 806 to the first and second waveguides where the holographic wavefront is replicated. After replication, the holographic projection system 800 may be arranged such that the replicated holographic wavefront is relayed to an optical combiner. At least a portion of the intensity of the holographic wavefront is reflected/relayed by the optical combiner to an eye-box.

There have been disclosed different ways of increasing the field of view of the display system. GB 2308737.2 and GB 2308743.0 of 12 Jun. 2023 discloses a method comprising dividing a target picture into a plurality of portions and deflecting light by first and second deflection angles using a wavefront redirector. GB 2407680.4 of 30 May 2024 disclose an improved method of spatially interlacing a first sub-hologram and second sub-hologram using a “pixel binning” approach. GB 2407683.8 of 30 May 2024 discloses an improved wavefront redirector arranged to provide opposing diagonal turns.

There is described herein an alternative way of increasing the field of view or etendue of a display device for holograms or a holographic projection system.

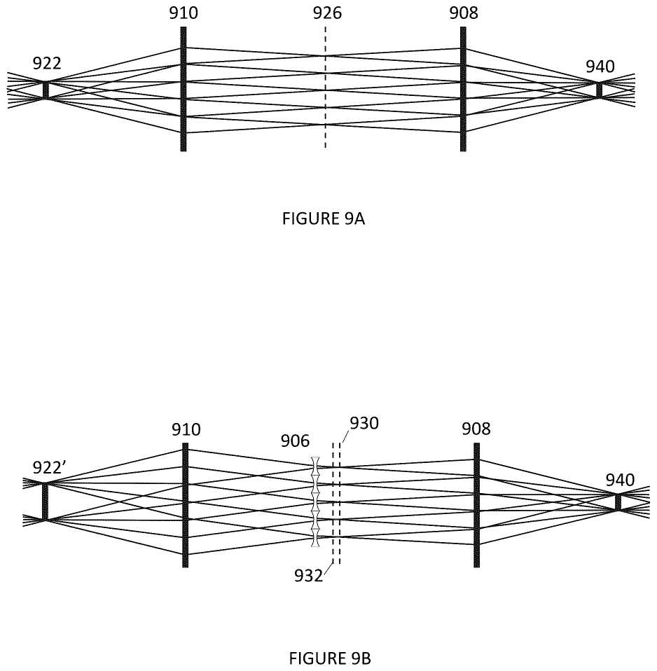

FIG. 9A shows a schematic cross-sectional view of a 4f optical system arranged to relay a hologram displayed on a display device 940, such as an LCOS SLM as described elsewhere herein. The 4F optical system comprises a first lens 908 and a second lens 910 downstream of the first lens 908. The first lens 908 and the second lens 910 are arranged (as in FIG. 8) such that the back focal plane of the first lens 908 is coplanar with the front focal plane of the second lens 910 at plane 926. The display device 940 is positioned at a front focal plane of the first lens 908.

The first lens 908 receives a holographic wavefront from the display device 940 and focuses the wavefront at Fourier plane 926 to form a holographic reconstruction. The holographic wavefront continues to propagate through the 4F optical system towards the second lens 910. The second lens 910 is arranged to receive the holographic wavefront and form a relayed hologram 922 at the back focal plane of the second lens 910. The relayed hologram 922 corresponds to (an image of) the display device 940.

As would be understood by the skilled person, a spatial filtering component (not shown) may be placed at the plane 926 (also referred to as a Fourier plane) to apply a spatial filter to the holographic reconstruction.

In some embodiments, the first lens 908 and the second lens 910 have the same focal length f. In this instance, the magnification factor applied by the 4F optical system is 1, such that the relayed hologram 922 is the same size as the display device 940. In other words, the etendue of the relayed hologram 922 is the same as that of the light propagating from display device 940. The field of view of the relayed hologram also remains unchanged compared to the field of view of the hologram propagated from the display device 940.

FIG. 9B shows a schematic cross-sectional view of an etendue expander according to embodiments disclosed herein. Like the 4F system shown in FIG. 9A, the etendue expander comprises a first lens 908 and a second lens 910. However, the etendue expander also includes a microlens array 906 arranged between the first and second lenses. In the embodiment shown in FIG. 9B, the microlens array 906 comprises an array of negative microlenses positioned between the second lens 910 and the back focal plane 930 of the first lens 908.

The first lens 908 forms an holographic reconstruction of the hologram at the back focal plane 930 of the first lens 908. The holographic reconstruction comprises a plurality of pixels, which can alternatively be understood as “spots” in the holographic reconstruction. Each pixel or spot can be considered as a point object which is then imaged by a corresponding microlens of the microlens array 906 to form an image of the pixel at a larger angle.

The microlens array 906 forms an image of the plurality of pixels of the holographic reconstruction at the front focal plane 932 of the second lens 910. As can be seen, the back focal plane of the first lens 930 and the front focal plane of the second lens 932 are axially displaced from one another, in contrast to the optical relay illustrated in FIGS. 8 and 9A where they are coplanar. The length of axial displacement (i.e. the distance between the back focal plane 930 of the first lens 908 and the front focal plane 932 of the second lens 910) may be denoted as d. The total optical length of the etendue expander may therefore be calculated as 2*(f1+f2)+d. If f1=f2=f, then the total length is 4f+d.

The microlens array 906 shown in the embodiment of FIG. 9B can be considered as imparting a divergence on the holographic wavefront optically downstream of the back focal plane 930 of the first lens 908 such that the angular size of a light ray bundle is greater downstream of the microlens array 906 compared to the angular size of the light ray bundle upstream of the microlens array 906.

The holographic wavefront continues to propagate from the microlens array 906 to the second lens 910. The second lens 910 forms a relayed hologram 922′ at the back focal plane of the second lens 910. As can be seen, the relayed hologram 922′ is larger than the hologram displayed on the display device 940. It can therefore be understood that the etendue of the relayed hologram 922′ is greater than that of the hologram displayed on display device 940 by virtue of the increased angular size of light ray bundles provided by the microlens array 906.

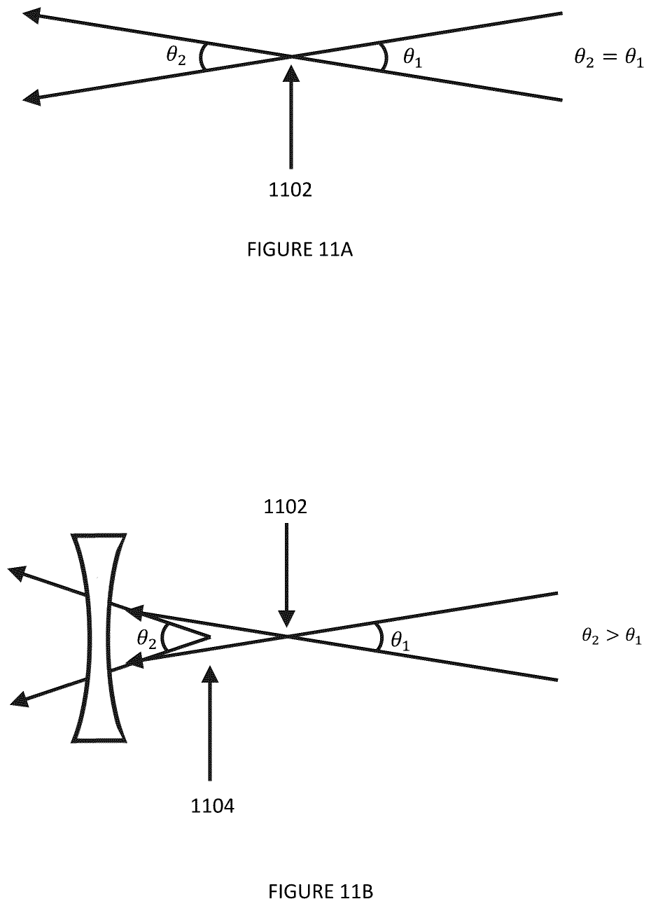

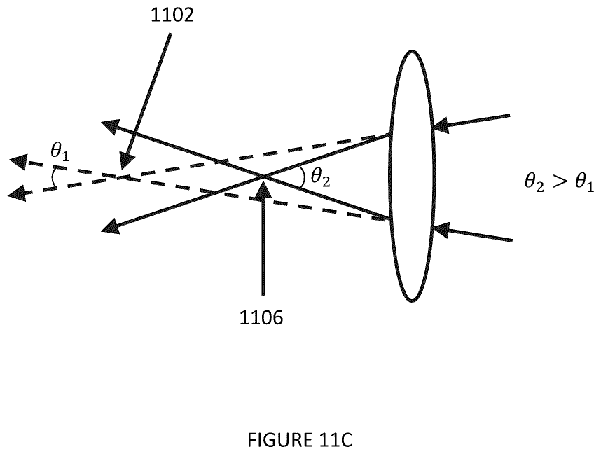

In alternative embodiments, the etendue expander may comprise a microlens array formed of positive microlenses (not shown). The effect of using a positive microlens array is discussed below with reference to FIG. 11C. The positive microlens array in these embodiments may be positioned on the opposite side of the focal plane of the first lens. The positive microlenses may therefore form an image of the pixels of the holographic reconstruction upstream of the back focal plane of the first lens. In an opposite configuration to that shown in FIG. 9B, the second lens 910 may therefore be positioned to have its front focal plane 932 upstream of the back focal plane 930 of the first lens 908. In this way, the front focal plane 932 of the second lens 910 is displaced upstream by distance d (assuming that the positive microlenses have the inverse focal length of the negative microlenses discussed above). The total optical length of the etendue expander may therefore be calculated as 2*(f1+f2)−d. If f1=f2=f, then the total length is 4f-d. This arrangement may be beneficial since the size of the etendue expander is reduced, making this embodiment synergistic with automotive applications where space-saving considerations, even small ones, are a priority.

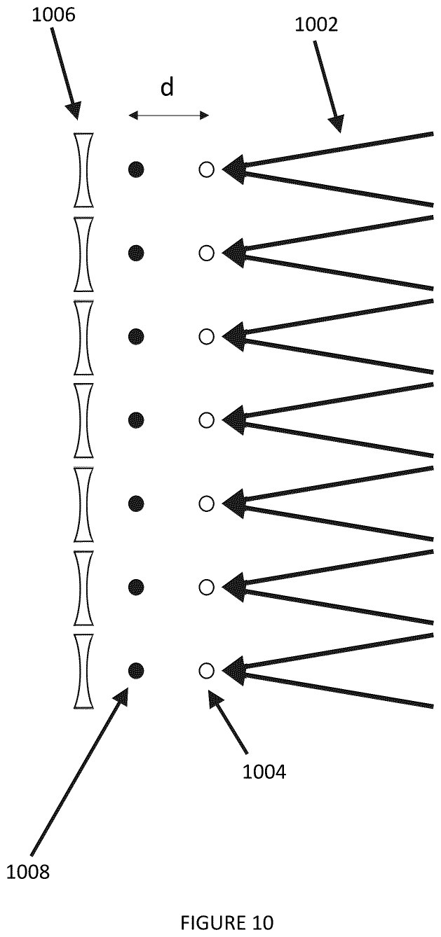

FIG. 10 shows in more detail how a microlens array forms an image of the plurality of pixels of an holographic reconstruction. Specifically, incoming light rays 1002 are focused by the first lens (not shown) to form the holographic reconstruction comprising a plurality of pixels 1004. A negative microlens array 1006 is shown as having each microlens aligned with a respective pixel of the holographic reconstruction. In some embodiments and as illustrated, each microlens is positioned such that its optical axis is centred on the corresponding pixel of the holographic reconstruction. The microlenses 1006 therefore form an image 1008 of the plurality of pixels of the holographic reconstruction. In the illustrated embodiment, the image of the pixels formed by the negative microlenses are axially displaced from the holographic reconstruction pixels 1004 by a distance d. As an illustrative example, the axial displacement d may be in the range of a few millimetres (e.g. 3 mm) to the sub-millimetre range (e.g. 300 micrometres). The focal length of the microlenses may, for example, be in the range of a few hundred millimetres e.g. 100-300 mm).

Furthermore, the light rays corresponding to each pixel may be focused only by the corresponding microlens. In order words, each microlens is positioned proximate to the holographic reconstruction such that light corresponding to each pixel of the holographic reconstruction falls only on the respective microlens. This means that each pixel of the holographic reconstruction is equally affected by the plurality of microlenses. Therefore, the phase of each pixel is equally affected by the microlenses, so the plurality of microlenses does not impart any relative phase differences for the plurality of pixels. The microlens approach for expanding etendue disclosed herein is therefore particularly synergistic with use in a holography application.

The embodiment illustrated in FIG. 10 shows a plurality of negative microlenses. However, in other embodiments the plurality of microlenses may be positive lenses. In such embodiments, the positive microlenses may therefore form an image of the pixels of the holographic reconstruction upstream of the back focal plane of the first lens.

FIG. 11A shows the formation of a holographic reconstruction pixel 1102 in the absence of a microlens. Light rays corresponding to a holographic reconstruction pixel 1102 come to a focus at an angle of θ1. The light rays corresponding to holographic reconstruction pixel 1102 continue to propagate at an angle of θ2 which is equal to the incident angle θ1. In other words, in the absence of a microlens, θ2=θ1. It is therefore seen that the etendue of the propagating light remains unchanged in the absence of a microlens. The embodiment of FIG. 11A can be understood as the formation of the Fourier plane in a conventional 4f lens system.

FIG. 11B shows a holographic reconstruction pixel 1102 with the addition of a negative microlens (e.g. as shown in FIGS. 9B and 10). The incoming light rays that form the holographic reconstruction pixel 1102 have an angle of θ1 (as in FIG. 11A). The light rays then pass through the negative microlens which imparts a divergence onto the light rays. The light rays exiting the microlens have an angle of θ2 which, due to the effect of the microlens, is larger than θ1. In other words, due to the presence of the microlens, θ2>θ1. Therefore, the etendue of the light rays is increased by the action of the microlens. The change in angle of the light rays also means that a new image 1104 is formed by the microlens of the holographic reconstruction pixel 1102. In this embodiment which uses a negative microlens, the new image 1104 is formed optically downstream of the original holographic reconstruction. The precise amount of axial displacement d between 1102 and 1104 is dependent on the focal length of the microlens, and the focal lengths of the first/second lenses.

FIG. 11C shows an embodiment where the microlens is a positive lens. In this embodiment, the positive microlens is placed optically upstream of the holographic reconstruction pixel 1102. The light rays for each holographic reconstruction pixel are then focused by the positive microlens to form a new image 1106 of the holographic reconstruction pixel 1102. The angle of light rays exiting the positive microlens have an angle of θ2 which, due to the effect of the microlens, is larger than θ1. In other words, due to the presence of the microlens, θ2>θ1. Therefore, the etendue of the light rays is increased by the action of the microlens. The new image 1106 is formed by the microlens optically upstream of the original holographic reconstruction pixels 1102. The amount of axial displacement depends upon the focal length of the microlens, and the focal lengths of the first/second lenses. As can be appreciated, the upstream axial displacement of the original holographic reconstruction to the new image formed by the positive microlens allows a shortening of the overall optical length of the etendue expander.

### Additional Features

The methods and processes described herein may be embodied on a computer-readable medium. The term “computer-readable medium” includes a medium arranged to store data temporarily or permanently such as random-access memory (RAM), read-only memory (ROM), buffer memory, flash memory, and cache memory. The term “computer-readable medium” shall also be taken to include any medium, or combination of multiple media, that is capable of storing instructions for execution by a machine such that the instructions, when executed by one or more processors, cause the machine to perform any one or more of the methodologies described herein, in whole or in part.

The term “computer-readable medium” also encompasses cloud-based storage systems. The term “computer-readable medium” includes, but is not limited to, one or more tangible and non-transitory data repositories (e.g., data volumes) in the example form of a solid-state memory chip, an optical disc, a magnetic disc, or any suitable combination thereof. In some example embodiments, the instructions for execution may be communicated by a carrier medium. Examples of such a carrier medium include a transient medium (e.g., a propagating signal that communicates instructions).

It will be apparent to those skilled in the art that various modifications and variations can be made without departing from the scope of the appended claims. The present disclosure covers all modifications and variations within the scope of the appended claims and their equivalents.

What is claimed is:

1. An etendue expander for a display, the etendue expander comprising:
a first lens arranged to form a holographic reconstruction of a hologram displayed at a first focal plane thereof, wherein the holographic reconstruction comprises a plurality of pixels;
a plurality of microlenses, wherein each microlens is aligned with a respective pixel of the holographic reconstruction to form an image of the plurality of pixels; and
a second lens arranged such that the image of the plurality of pixels is disposed at a first focal plane thereof and a relayed hologram is formed at a second focal plane thereof, wherein an etendue of the relayed hologram is greater than that of the hologram.

2. The etendue expander of claim 1, wherein the plurality of microlenses are arranged in a pattern corresponding to a pattern of the plurality of pixels of the holographic reconstruction.

3. The etendue expander of claim 1, wherein the plurality of microlenses is positioned proximate to the holographic reconstruction such that light corresponding to each pixel of the holographic reconstruction falls only on the respective microlens.

4. The etendue expander of claim 1, wherein the etendue of the relayed hologram is selectable based on a distance of the plurality of microlenses from the holographic reconstruction.

5. The etendue expander of claim 1, wherein the first lens and the second lens have a same focal length.

6. The etendue expander of claim 1, wherein an angular size of light ray bundles entering the plurality of microlenses from the first lens is greater than an angular size of light ray bundles exiting the plurality of microlenses.

7. The etendue expander of claim 1, wherein the plurality of microlenses comprises positive lenses.

8. The etendue expander of claim 5, wherein the plurality of microlenses is positioned between the first lens and the holographic reconstruction.

9. The etendue expander of claim 1, wherein the plurality of microlenses comprise negative lenses.

10. The etendue expander of claim 9, wherein the plurality of microlenses is positioned between the second lens and the holographic reconstruction.

11. The etendue expander of claim 1, wherein the etendue expander is optically connectable via the second lens to a waveguide.

12. The etendue expander of claim 1, wherein a field of view of the relayed hologram and the hologram are the same.

13. The etendue expander of claim 1, further comprising a spatial filtering component positioned at a Fourier plane of the etendue expander.

14. A method of expanding an etendue of a holographic wavefront, comprising:
forming a holographic reconstruction of a hologram at a first focal plane of a first lens, wherein the holographic reconstruction comprises a plurality of pixels;
forming an image of the plurality of pixels with a plurality of microlenses, wherein each microlens is aligned with a respective pixel of the holographic reconstruction; and
forming a relayed hologram at a first focal plane of a second lens wherein the image of the plurality of pixels is disposed at a second focal plane thereof, wherein an etendue of the relayed hologram is greater than that of the hologram.

15. A system comprising:
a first lens arranged to form a holographic reconstruction of a hologram displayed at a first focal plane thereof, wherein the holographic reconstruction comprises a plurality of pixels;
a plurality of microlenses, wherein each microlens is aligned with a respective pixel of the holographic reconstruction to form an image of the plurality of pixels;
a second lens arranged such that the image of the plurality of pixels is disposed at a first focal plane thereof and a relayed hologram is formed at a second focal plane thereof, wherein an etendue of the relayed hologram is greater than that of the hologram; and
a first waveguide optically connected to the second lens, the first waveguide configured to receive the relayed hologram and replicate the relayed hologram along a first dimension.

16. The system of claim 15, further comprising a second waveguide optically connected to the first waveguide, wherein the second waveguide is configured to replicate the relayed hologram in a second dimension.

17. The system of claim 15, wherein the first lens and the second lens have a same focal length.

18. The system of claim 15, wherein a field of view of the relayed hologram and a field of view of the hologram are the same.

19. The system of claim 15, wherein the plurality of microlenses is positioned proximate to the holographic reconstruction such that light corresponding to each pixel of the holographic reconstruction falls only on a respective microlens.

20. The system of claim 15, further comprising a spatial filtering component positioned at a Fourier plane between the first lens and the second lens.
